(19) United States
(12) Patent Application Publication
(10) Pub. No.: US 2025/0129805 A1
(43) Pub. Date: Apr. 24, 2025

(54) ARRANGEMENT FOR VALVE CONTROL

(71) Applicant: DEERE & COMPANY, MOLINE, IL (US)

(72) Inventor: VOLKER KEGEL, MANNHEIM (DE)

(21) Appl. No.: 18/910,031

(22) Filed: Oct. 9, 2024

(30) Foreign Application Priority Data
Oct. 18, 2023 (DE) 102023128609.9

(51) Int. Cl. F15B 13/08

(52) U.S. Cl. CPC F15B 13/085; F15B 13/086

(57) ABSTRACT

An arrangement for valve control includes a control unit and at least one valve device which can be activated via the control unit. The at least one valve device includes an electric coil electrically connected to the control unit via at least one supply line for valve actuation. A coil current is generated in the at least one supply line of the coil depending on a PWM signal of the control unit. The at least one valve device includes an electronic communication unit electrically connected to the at least one supply line via at least one connecting line for a power supply.

### CROSS-REFERENCE TO RELATED APPLICATIONS

This application claims priority to German Patent Application No. 102023128609.9, filed Oct. 18, 2023, which is hereby incorporated by reference.

### FIELD OF THE DISCLOSURE

The disclosure relates to an arrangement for valve control.

### BACKGROUND

An electrical signal can activate an electrical coil of a hydraulic valve to control a hydraulic pressure or a volumetric flow through the hydraulic valve.

### SUMMARY

The disclosure relates to an arrangement for valve control having a control unit and at least one valve device which can be activated by the control unit and which contains an electric coil for valve actuation, it being possible to generate a coil cur-rent in the supply lines of the coil depending on a PWM signal of the control unit.

Such an arrangement is known from DE 10 2015 205 222 A1. In this case, a hydraulic valve device is connected to a control which activates an electric coil of the hydraulic valve by means of a PWM (pulse width modulation) signal. In order to control a hydraulic pressure or a volumetric flow through the hydraulic valve, the duty cycle of the PWM signal can be influenced. Inside a hydraulic system, one or more of the previously mentioned valve devices can be used and activated by a suitable control.

The disclosure is based on the object of improving the technical interaction between a control and at least one valve device.

This object is achieved by an arrangement having the features of one or more of the following embodiments.

Further advantageous embodiments of the arrangement according to the disclosure can be found herein.

According to the disclosure, an arrangement for valve control is proposed, having a control unit and at least one valve device which can be activated by the control unit. The valve device contains an electric coil for its valve actuation, i.e. for achieving a through-flow opening for a medium (e.g. gas or liquid) flowing through the valve device. In the electrical supply lines of the coil, a coil current can be generated depending on a PWM signal (e.g. by means of a suitable driver) of the control unit. The valve device has an electronic communication unit which is electrically connected to the power lines of the coil by suitable connecting means (e.g. electrical lines, stranded wires).

The integration of the electronic communication unit into the valve device creates the prerequisite for an intelligent valve device which can operate a data communication (sending and/or receiving) with the control unit and/or other technical units in a suitable technical manner. This communication for example comprises valve-specific data of the valve device which then no longer have to be scanned and communicated to the control unit in a technically awkward manner. The use of the communication unit reduces the susceptibility to faults of the data communication with the control unit and/or other technical units. Maintenance and repair operations in connection with the valve devices can be carried out with little technical and time outlay. For example, in the case of a replacement of the valve device, the communication unit allows an automated transmission of the data (e.g. calibration parameters) belonging to the exchanged valve device without additional manual interventions.

The electronic communication unit can be designed as an electronic chip or circuit. For example, the communication unit contains properties and functions of a microcomputer.

For example, all of the valve devices contained in the arrangement are equipped with their own communication unit.

The supply of power to the communication unit takes place by means of the connecting means. For example, the communication unit contains an input stage having a rectifier and input current limitation and also a power buffer (e.g. capacitor). In this case, it is advantageous that the electrical energy required for the supply of power is so low that the behavior of the coil and consequently the valve device remains unaffected. In addition, the power supply of the communication unit can be ensured with minimum technical outlay.

For example, the supply lines of the coil and the connecting means are used in a multi-function manner as at least one data line, so that without additional technical outlay, a uni- or bidirectional communication between the control unit and the valve device can be realized. For example, the control unit can send certain identification data (e.g. data/security keys, passwords) to the valve device via this data connection. The wired data connection here ensures a unique assignment of the sent data to the respective valve device in the case of a plurality of valve devices. Thus, the valve devices can be uniquely differentiated from one another during technical operation according to the assignment of the previously mentioned data. For example, the individual valve devices can be uniquely and securely identified with respect to a superordinate technical system (e.g. on a system bus in a utility vehicle). If a valve device is replaced (e.g. owing to a case of repair), the new valve device can be identified with the same assigned key, but new valve-specific physical parameters.

Advantageously, the previously mentioned data keys or passwords in the control unit can be generated according to a principle of randomness or dynamically. They can support an encryption of the wireless communication of the communication unit.

Further, the duty cycle of the PWM signal can be chosen in such a manner for a satisfactory power supply of the communication unit that it is smaller than a limit duty cycle which corresponds to an at least required coil current for the valve actuation. Thereby, the PWM-based activation of the valve device can, in a multi-function manner, ensure the power supply of the communication unit also below the minimum required operating current for a valve actuation. In other words, small hitherto unused duty cycles can be used for the supply of power to the communication unit without additional technical outlay without affecting the technical operation of the valve device.

The duty cycle is for example defined as a time relationship between a switch-on phase and a switch-off phase in a constant period duration of the PWM signal.

In a further embodiment of the disclosure, below the previously mentioned limit duty cycle, PWM signals with different duty cycles can be used. Thereby, the control unit can build unidirectional communication to the communication unit of the valve device with encoded information (bits) without additional technical components being required. For example, two different duty cycles are used for the realization of the binary digits “0” and “1”. The control of the duty cycles can take place in the control unit with a precise time resolution, which supports fault-free communication with the valve device(s). Using the different duty cycles, it is also possible in a technically simple manner to achieve encoding of the information to be sent to the valve device, for example the previously mentioned identification data. The communication unit then decodes the received information, e.g. in that a counter times the pulse duration or the switch-on phase of the PWM signal.

For example, the communication unit contains a data memory. This is used for example to store valve-specific data, such as for example manufacturers, part numbers, operating/calibration parameters. As a result, the communication unit can fulfil the function of a digital nameplate. Each valve device can be identified in a unique and fault-free manner. For example, the valve device can in this manner store its valve-specific calibration data (e.g. characteristic curve, table) in digital form in such a manner that if required, the control unit or other technical units can receive these digital data in an automated manner. This facilitates the necessary knowledge of valve-specific data for example after a replacement of the valve device due to repair. The control unit can as a result take the mutually different calibration data of individual valve devices into account in a technically simple manner, in order to activate the valve devices as accurately as possible on the basis of their current-dependent valve behavior.

In a further embodiment, the communication unit has a data interface for wireless communication. Different technologies can be used here, e.g. Bluetooth, Bluetooth LE, WiFi, Zigbee, Thread, Mesh-capable protocol.

The communication unit can be designed for bidirectional communication. In this case, the data interface for wireless communication can for example enable a bidirectional data exchange between the valve device and a technical unit. This technical unit can be a receiving unit which can communicate with a multiplicity of valve devices. Advantageously, this receiving unit is already used for other communication purposes (e.g. as a receiver in a utility vehicle for communication with a plurality of mobile telecommunications devices) and can therefore be provided without additional component outlay.

In connection with the receiving unit, the identification data sent to the individual valve devices can ensure that also only these valve devices communicate with the receiving unit. Any faults of the technical operation due to other components or valve devices is prevented by this.

For example, the valve device, particularly the communication unit thereof, contains a sensor, the sensor signals of which represent a physical state variable (e.g. temperature, pressure, current) of the valve device. This creates the prerequisite for monitoring or checking of a physical state of the respective valve device. The querying or taking account of a physical state of the valve device can be realized in a particularly technically simple manner if the sensor signals are read directly from the sensor and sent to relevant technical units (e.g. to a system bus in a utility vehicle) and/or to the control unit.

Alternatively, the sensor signals are stored at least to some extent in the data memory of the communication unit and are then read from the data memory depending on suitable technical criteria and transmitted to relevant technical units and/or to the control unit.

Therefore, the control unit and/or a different technical unit can access the sensor signals and take these into account during the activation of technical steps (e.g. a specific activation of the valve device or a different component).

Advantageously, at least one of the following steps is carried out by means of the arrangement:
The control unit sends identification data representing this valve device to the communication unit of the valve device. Here, the control unit can be in an identification mode prior to actual operation with the valve activation.
The communication unit sends a feedback signal via its data interface. The feedback signal can be sent to the control unit indirectly via the receiving unit. Using the feedback signal, a status (e.g. presence or operating state) of the respective valve device can be checked. This is of interest for example following a replacement or a repair on the valve device, in order to support fault-free operation of the arrangement. For example, the communication unit sends the feedback signal as a reaction to receipt of the identification data.
The control unit activates the valve activation, that is to say the actual technical operation, depending on a feedback signal of the valve device. As a result, technical faults can be excluded here in that the regular technical operation of the valve activation by means of the control unit is dependent on previous orderly feedback of the valve devices involved. To support efficient data exchange, the receiving unit and the control unit can communicate with one another in a suitable manner.

In an advantageous embodiment, the valve device is designed as a hydraulic valve for a control of a hydraulic liquid (e.g. oil). In this case, the valve device is for example designed as a hydraulic proportional valve. This proven technology can support a precise mode of operation of the arrangement.

The described arrangement can be used in a utility vehicle, for example an agricultural or forestry utility vehicle (e.g. tractor) or a construction machine. The control unit can activate one or more valve device(s) with the described advantages. A gear mechanism, for example the clutch(es) thereof, of the utility vehicle can be controlled depending on the state of the valve device(s).

The above and other features will become apparent from the following detailed description and accompanying drawings.

### BRIEF DESCRIPTION OF THE DRAWINGS

The disclosure is explained in greater detail below with reference to the appended drawings. Component parts of equivalent or comparable function are identified by the same reference signs in this case. In the drawings:

FIG. 1 shows a schematic illustration of a utility vehicle having the arrangement for valve control according to the disclosure; and

FIG. 2 shows an illustration in the manner of a block diagram of the arrangement according to the disclosure.

### DETAILED DESCRIPTION

The embodiments or implementations disclosed in the above drawings and the following detailed description are not intended to be exhaustive or to limit the present disclosure to these embodiments or implementations.

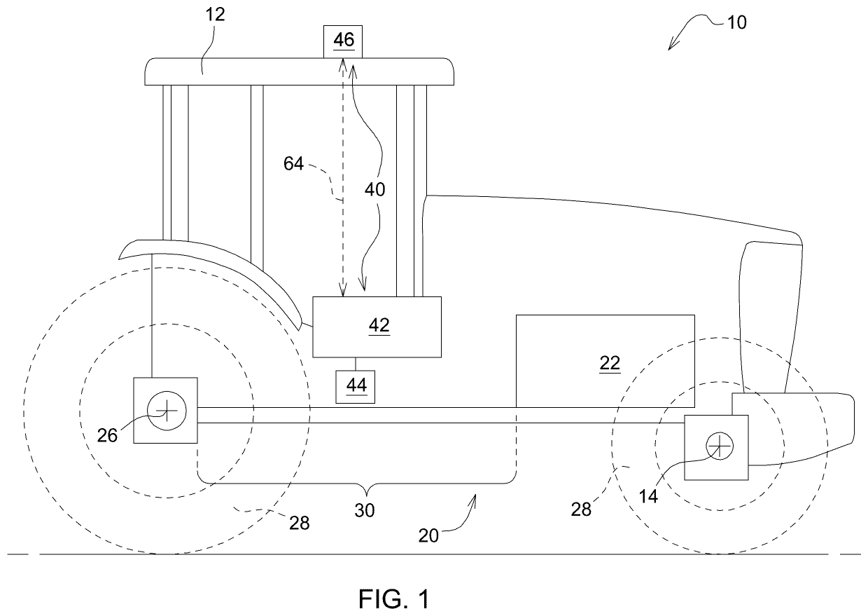

FIG. 1 shows a schematic illustration of an agricultural utility vehicle 10, for example in the form of a tractor, having a drivetrain 20. The utility vehicle 10 further comprises a cab 12, a front vehicle axle 14 and a rear vehicle axle 26. The utility vehicle 10 can have one or more ground engaging means in the form of wheels 28. The drivetrain 20 comprises a drive motor 22 which may be realized in the form of an internal combustion engine and a gear mechanism structure 30 which may be composed of different individual gear mechanism components.

The utility vehicle 10 has an arrangement 40 having a control unit 42 (e.g., a controller including a processor and memory), at least one valve device 44, one receiving unit 46 and, if appropriate, further components. The at least one valve device 44 can be designed as a hydraulic valve, for example a hydraulic proportional valve and can contribute to controlling the gear mechanism structure 30 or individual gear mechanism components.

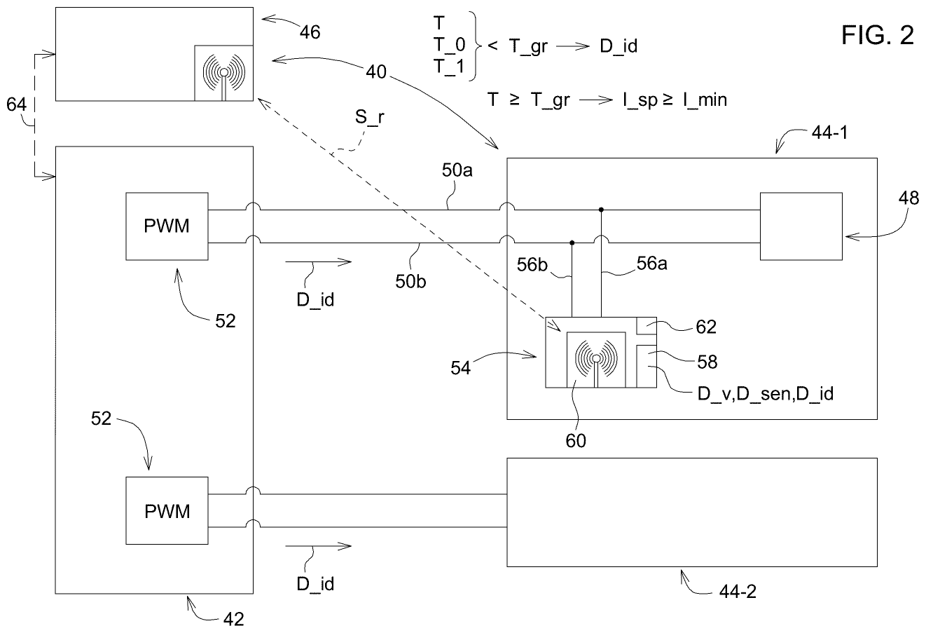

According to FIG. 2, two valve devices 44-1, 44-2 are provided by way of example, which are activated by the control unit 42. The control unit 42 can also activate any other number of valve devices 44. The structure and the mode of operation of the valve devices 44 used are explained in the following with reference to the valve device 44-1.

To actuate the valve device 44-1, i.e. to open the same for the through-flow of a hydraulic medium, the valve device 44-1 contains an electric coil 48, the magnetic field of which usually influences a through-flow element for controlling a hydraulic pressure or the hydraulic through-flow. The electrical supply lines 50a, 50b for the coil 48, which are designed as stranded wires, are connected to a driver 52. The latter provides an electric coil current I_sp for the coil 48 and activates the coil 48 using a PWM-based signal.

The valve device 44-1 has an electronic communication unit 54 and, for its supply with power, two connecting lines 56a, 56b are electrically connected to the supply lines 50a, 50b.

In addition, the connecting lines 56a, 56b are effective as data lines, so that the communication unit 54 can receive data from the driver 52, process it and, if appropriate, store it in a data memory 58. Here, the driver 52 provides the data on the basis of PWM signals, the duty cycle T of which is smaller than a limit duty cycle T_gr which corresponds to an at least required or minimum coil current I_min for the actuation of the valve device 44-1. Thus, it is ensured that the communication between the control unit 42 and the valve device 44-1 or the communication unit 54 does not impair the technical valve behavior, for example the valve actuation.

For example, at least two different duty cycles T_0 and T_1 are used, which are all smaller than the limit duty cycle T_gr. As a result, the control unit 46 can generate an encoded communication with the communication unit 54.

Different data can be stored in the data memory 58. For example, valve-specific data D_v, such as for example manufacturers, part numbers, operating parameters, calibration parameters (e.g. calibration characteristic curve, formula) are stored there. In addition, identification data D_id (e.g. passwords, security keys) sent from the control unit 46 to the communication unit 54 can be stored in the data memory 58.

Furthermore, the communication unit 54 has a data interface 60 for wireless communication. As a result, bidirectional communication with the receiving unit 46 is possible for example. The receiving unit 46 can be a receiver which is already present on the utility vehicle 10 for wireless communication, e.g. for receiving and sending for mobile telecommunications communication. The receiving unit 46 and the control unit 42 can likewise communicate with one another in a suitable technical manner, for example by means of one or more transmission line(s) 64.

The communication unit 54 contains a sensor 62, the sensor signals of which represent a physical state variable (e.g. temperature, pressure, current) of the valve device 44-1. In an embodiment, the sensor signals are stored at least to some extent as data D_sen in the data memory 58. The stored data D_sen can be read via the data interface 60 and for example communicated to the receiving unit 46 or a system bus of the utility vehicle 10.

In connection with the technical operation of the arrangement 40, the following described method steps for example can be carried out.

As soon as the control unit 42 is switched on, i.e. is supplied with an operating voltage, it sends its respective identification data D_id, e.g. password and/or data key, to all connected valve devices 44. Here, duty cycles T below the limit duty cycle T_gr can be used, so that still no valve actuation or valve activation takes place. Using the identification data D_id, the valve devices 44 can be securely and uniquely identified in a vehicle system, e.g. a bus system and components that are connected thereto.

The control unit 42 initially waits for the feedback of all valve devices 44 that are connected and supplied with identification data D_id. This feedback can take place via the data interface 60 and the receiving unit 46. Thereafter, the control unit 42 goes into the actual operation of activating the valve devices 44 or the coils 48 for the valve actuation.

For the previously mentioned feedback of the valve devices 44, the respective communication unit 54 can send a feedback signal S_r via its data interface 60 and/or other specific signals such as stored data for example to the receiving unit 46. The control unit 42 receives corresponding signals or data from the receiving unit 46. As a result, prior to the actual operation of the valve activation, a unique assignment of the valve devices 44 to the control unit 42 can be ensured. For example, following a replacement or repair, new valve devices 44 can securely be detected. Without orderly feedback, faults in connection with individual connected valve devices 44 can be detected even before the actual technical operation of the arrangement 40.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. An arrangement for valve control comprising:
a control unit; and
at least one valve device which can be activated via the control unit, the at least one valve device including an electric coil electrically connected to the control unit via at least one supply line for valve actuation, a coil current being generated in the at least one supply line of the coil depending on a PWM signal of the control unit, and the at least one valve device including an electronic communication unit electrically connected to the at least one supply line via at least one connecting line for a power supply.

2. The arrangement of claim 1, wherein the at least one connecting line is effective as at least one data line.

3. The arrangement of claim 1, wherein for the power supply of the electronic communication unit, a duty cycle of the PWM signal is smaller than a limit duty cycle which corresponds to an at least required coil current for the valve actuation.

4. The arrangement of claim 3, wherein the PWM signals have different duty cycles.

5. The arrangement of claim 1, wherein the electronic communication unit contains a data memory.

6. The arrangement of claim 1, wherein the electronic communication unit has a data interface for wireless communication.

7. The arrangement of claim 1, wherein the electronic communication unit is designed for bidirectional communication.

8. The arrangement of claim 1, wherein the electronic communication unit is designed for communication with a receiving unit that is external with respect to the valve device.

9. The arrangement of claim 1, wherein the valve device includes a sensor having sensor signals which represent a physical state variable of the valve device.

10. The arrangement of claim 1, wherein the electronic communication unit includes a sensor having sensor signals which represent a physical state variable of the valve device.

11. The arrangement of claim 10, wherein the sensor signals are stored at least to some extent in the data memory of the electronic communication unit.

12. The arrangement of claim 1, wherein the valve device is designed as a hydraulic valve.

13. The arrangement of claim 12, wherein the valve device is designed as a proportional valve.

14. The arrangement of claim 1, wherein the control unit is configured to send identification data representing this valve device to the electronic communication unit of the valve device.

15. The arrangement of claim 1, wherein the electronic communication unit is configured to send a feedback signal via its data interface.

16. The arrangement of claim 1, wherein the control unit is configured to activate the valve activation depending on a feedback signal of the electronic communication unit.

17. The arrangement of claim 1, wherein:
the control unit is configured to send identification data representing this valve device to the electronic communication unit of the valve device;
the electronic communication unit is configured to send a feedback signal via its data interface; and
the control unit is configured to activate the valve activation depending on a feedback signal of the electronic communication unit.

18. The arrangement of claim 1, wherein the arrangement is used for controlling a gear mechanism in an agricultural utility vehicle.
